(19) United States
(12) Patent Application Publication
(10) Pub. No.: US 2021/0083259 A1
(43) Pub. Date: Mar. 18, 2021

(54) INDUSTRIAL TRUCK COMPRISING AN ELECTRICAL ENERGY STORAGE DEVICE

(71) Applicant: Jungheinrich Aktiengesellschaft, Hamburg (DE)

(72) Inventors: Oliver Goepner, Oering (DE); Susanne Schoeler, Hoisdorf (DE); Christian Wegner, Moorrege (DE); Martin von Werder, Ammersbek (DE)

(73) Assignee: Jungheinrich Aktiengesellschaft, Hamburg (DE)

(21) Appl. No.: 17/019,988

(22) Filed: Sep. 14, 2020

(30) Foreign Application Priority Data
Sep. 16, 2019 (DE) 10 2019 124 873.6

(51) Int. Cl. H01M 2/34; H01M 10/48; H01M 10/42

(52) U.S. Cl. CPC H01M 2/34; H01M 2220/20; H01M 10/4207; H01M 10/48

(57) ABSTRACT

An industrial truck comprises at least one electrically powered drive and an electrical energy storage device. The electrical storage device comprises a battery management system (BMS) comprising a first housing including one or more electrical terminals. The electrical storage device further comprises at least one battery module comprising a second housing including one or more electric terminals.

### CROSS REFERENCE TO RELATED INVENTION

This application is based upon and claims priority to, under relevant sections of 35 U.S.C. § 119, German Patent Application No. 10 2019 124 873.6, filed Sep. 16, 2019, the entire contents of which are hereby incorporated by reference.

### TECHNICAL FIELD

The present invention relates to an industrial truck comprising at least one electrically powered drive and an electrical energy storage device. The electrically powered drive may for example be a travel drive, but other electrically powered drives are also possible in the industrial truck. The electrical energy storage device comprises a battery management system and at least one battery module. The battery management system controls and monitors the operation of the battery module, in particular in the case of solid-state and/or ion batteries. The battery management system may for example perform the task of monitoring the voltage in individual battery cells of a battery module.

### BACKGROUND

An industrial truck comprising a battery-powered electric drive is known from DE 10 2013 113 809 A1. The electrical energy storage device is composed of at least two sub-batteries, each consisting of battery modules, each of the battery modules being maintenance-free and the sub-batteries being mounted at precisely defined positions in the industrial truck. This makes it possible to arrange the battery modules in the vehicle in a more flexible manner, instead of a large monolithic battery block.

A system for storing electrical energy in a hybrid or electric vehicle is known from DE 10 2009 020 178. A hybrid controller that decides, inter alia, whether and how much energy is withdrawn from or fed to the energy storage device is provided for controlling the flow of energy in the hybrid vehicle. A battery management system is provided for each energy storage device and, additionally, corresponding contactors or switching elements are provided, via which an electrically conductive connection for the battery is established for safety reasons.

### BRIEF SUMMARY OF THE INVENTION

The object of the invention is to provide an industrial truck comprising an electrical energy storage device and that integrates a modular energy storage device in the vehicle in order to save space.

An embodiment of an industrial truck comprises at least one electrically powered drive and an electrical energy storage device, which comprises a battery management system and at least one battery module. In an embodiment, the at least one battery module and the battery management system each comprise a housing having electric terminals. In addition, the housings are arranged in the industrial truck so as to be spatially separated from one another, the battery management system comprising at least one switch, by means of which a connection between the at least one battery module and the electrically powered drive can be interrupted. In an embodiment, the industrial the switches are provided for safety reasons, in particular the contactor to be provided for each electric phase winding, are not provided in the battery modules but rather centrally in the battery management system. As a result, in the case of an electrical energy storage device comprising more than one battery module, the installation space in the module is saved for the additional contactors. In summary, the battery modules are more compact and thus can be used more flexibly in the industrial truck.

In an embodiment, the at least one battery module comprises a plurality of battery cells. Furthermore, the battery module does not comprise a switch that can interrupt the connection between the battery cells and the electric terminals of the relevant battery module. Switches of this kind are provided in the battery management system in the form of contactors, for example. If it is necessary to interrupt the electrical connection for one of the electric terminals of the battery, this can be done by means of the corresponding switch in the battery management system. This also applies to safety functions of the relevant battery module, which are also performed by the switch in the battery management system.

In an embodiment, the industrial truck is equipped with an on-board charging socket, which is connected to the battery management system. The charging power can be passed on to the at least one battery module via the connection. Likewise, control signals and status information relating to the battery and charging process can be passed on to the battery management system via the charging socket or vice versa from the battery management system via the charging socket to an external control system.

In an development, a bus bar module is provided, which connects a negative terminal of the at least one battery module to the at least one electric drive. In this embodiment, the electric circuit for the electric drive is closed via the battery management system for the positive terminal and via the bus bar module for the negative terminal.

In another embodiment, the electrical energy storage device is equipped with two or more battery modules, which are controlled by a common battery management system. Preferably, the two battery modules are also arranged in the vehicle so as to be spatially separated from one another and are interconnected accordingly via electric lines or bars.

In another embodiment, each battery module comprises a plurality of battery stacks. In an embodiment, a stack controller or alternatively a group of cell controllers is provided for each battery stack, which stack controller or group of cell controllers detects the voltage, temperature, power and other parameters for the relevant stack using sensors and controls, in an open-loop or closed-loop manner, using a corresponding control system. The stack controller forms the logical basis of the battery management system. To this end, a plurality of stack controllers are preferably connected to the battery management system.

In an embodiment, the battery management system is accommodated in a housing, which comprises a plurality of power contacts for the battery modules and at least one output contact for the electric loads. Each power contact is preferably equipped with a contactor that can disconnect the electrical power contact.

In another embodiment, the power and/or output contacts are integrated in the housing of the battery management system. Said integration can be achieved, for example, by injection-molding or casting the contacts in the housing material. By casting or injection-molding metal contacts in the plastics material, a highly effective connection can be produced with simple means. Preferably, current sensors for the plurality of power contacts are also provided in the housing of the battery management system. The current sensors may for example detect an overcurrent in order to switch the contactor accordingly.

In another embodiment, the battery management system comprises a terminal for an electric plug connector. The terminal may for example be in the form of a recessed holder for the electric plug connector, which is then merely inserted accordingly into the holder. In another embodiment, a signal line is provided for bidirectional signal exchange between the battery management system and the at least one battery module.

### BRIEF DESCRIPTION OF THE DRAWINGS

A preferred exemplary embodiment of the invention is explained in greater detail below based on the figures. In the drawings:

FIG. 1 illustrates a schematic depiction of an embodiment of an electrical energy storage device of an industrial truck;

FIG. 2 illustrates a schematic view of the embodiment of an electrical energy storage device comprising two identical battery modules and a BMS module;

FIG. 3 illustrates a schematic view of an embodiment of the electrical energy storage device comprising a battery management system and a battery module that has double the capacitance of the battery module from FIG. 1;

FIG. 4 illustrates a schematic view of an embodiment of the electrical energy storage device comprising two battery modules that have different capacitances;

FIG. 5a illustrates a front perspective view of an embodiment of a housing of the battery management system; and

FIG. 5b illustrates a rear perspective view of an embodiment of a housing of the battery management system

### DETAILED DESCRIPTION OF THE INVENTION

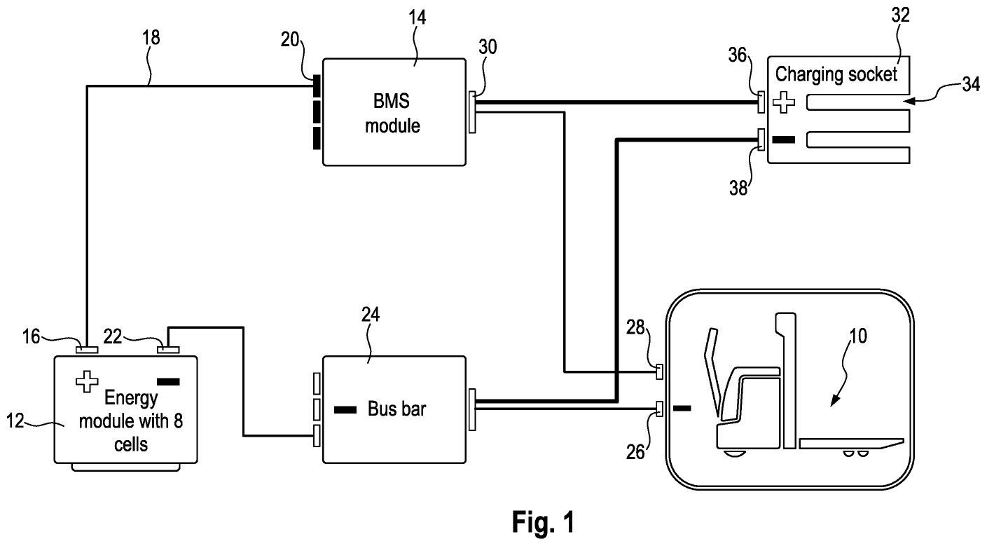

FIG. 1 is a schematic view of a tiller-controlled industrial truck 10, which comprises an electric travel drive and possibly an electrically actuated lift drive. The electric drive or drives are powered by a battery module 12. The battery module 12 comprises a sealed housing, which is equipped with electric contacts for the positive and negative terminal. Contacts for a data or signal line by means of which the battery module 12 is connected to a battery management system 14 are not shown here. The battery management system 14 comprises its own housing, which is arranged in the industrial truck 10 so as to be spatially separated from the battery module 12. The positive terminal 16 of the battery module 12 is connected via a line 18 to a power terminal 20 of the battery management system 14. The battery management system 14 also comprises a data and signal line (not shown), by means of which status signals and data can be received from the battery module 12. A negative terminal 22 of the battery module 12 is connected via a bus bar 24 to a negative terminal 26 on the industrial truck. In FIGS. 1 to 4, this connection is symbolically represented and shows the negative terminal 26 and the positive terminal 28 of the electric load supplied by the battery module 12. The terminal 28 is connected to an output terminal 30 of the battery management system 14. The electric load or loads in the industrial truck 10 are connected by their terminal contacts 26 and 28 via the bus bar 24 and the battery management system 14 to the battery module 12.

As also shown in FIG. 1, the industrial truck 10 may be equipped with a charging socket 32. The charging socket 32 is provided as a permanent feature of the vehicle and comprises a plug socket 34 that is accessible from outside. The charging socket 32 is electrically connected via its contacts 36, 38 either to the output contact 30 of the battery management system or to the bus bar 24. The charging socket 32 may additionally be provided with a signal line for the exchange of data and signals. Said signal line may for example be directly connected to a vehicle control or it may be in contact with the battery management system 14. During operation, the charging socket ensures, for example via said signal line, that an immobilizer on the vehicle is activated. For a charging procedure, the energy module 12 is supplied via contacts 36 and 38 of the charging socket 32, the charging current flowing via the battery management system 14 and the bus bar 24.

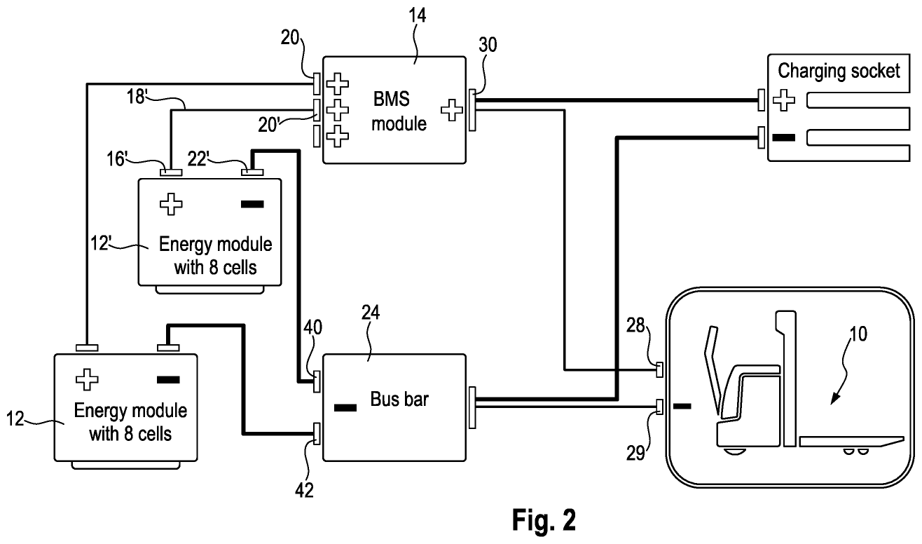

FIG. 2 shows a simple extension of the energy storage device. The same components are denoted by the same reference signs as in FIG. 1. The additional battery module 12′ is structurally identical to the battery module 12, and both battery modules each have eight cells. The additional battery module 12′ is connected by its positive terminal 16′ via a line 18′ and a power contact 20′ to the battery management system 14. The battery management system processes the electrical power applied by the battery modules 12 and 12′ in order to apply said power jointly via the output 30 to the corresponding contact 28. The associated negative terminal 29 also belongs to the industrial truck 10. The contact 22′ of the battery module 12′ is in contact with the bus bar 24 via the terminal 40. In FIG. 2, the contact 22 of the battery module 12 is in contact with a second terminal 42 of the bus bar 24. Although terminals 40, 42 are shown as separate terminals, they could also be designed as a joint terminal on the bus bar 24. The connected negative terminals 20, 22′ of the battery modules are brought together in the bus bar 24 and are jointly in contact with the terminal 26 of said bus bar.

Aside from the spatial separation of the modules in the industrial truck and the resulting greater flexibility of their arrangement in the interior, the exemplary embodiment with two battery modules also showcases another advantage. Since the same battery management system 14 is used in the configuration from FIG. 1 and in the configuration from FIG. 2.

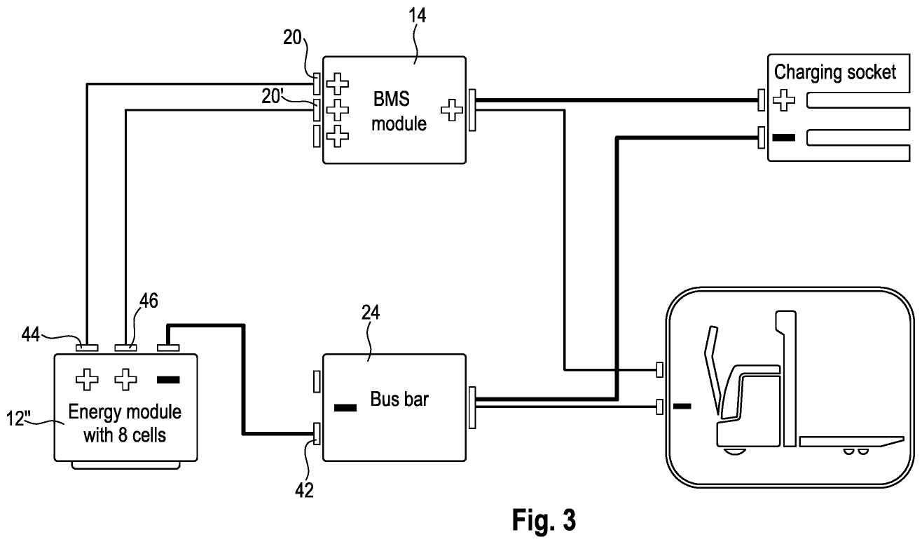

FIG. 3 shows another alternative embodiment of the electrical energy storage device. In this case, too, the same reference signs are used for the same components from FIGS. 1 and 2. In the configuration shown, a battery module 12″ comprising two terminal contacts 44, 46 is provided. The terminal contacts 44, 46 each conduct approximately one half of the current to the power contacts 20, 20′ of the battery management system 14. It is important to note that, here, the two power contacts 20, 20′, even though they are both connected to a battery module 12′, are the same terminals as in the exemplary embodiment from FIG. 2, in which two battery modules 12, 12′ are connected to the battery management module 14.

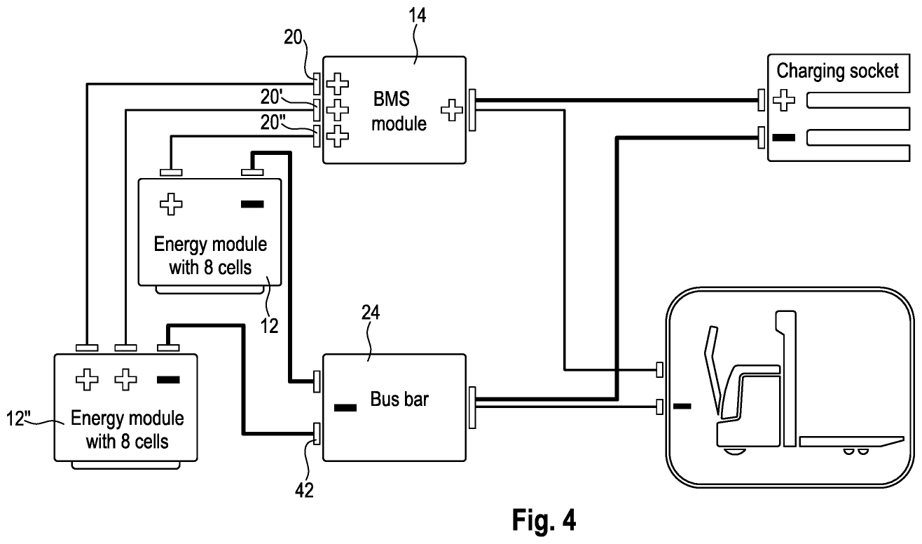

FIG. 4 shows a hybrid exemplary embodiment, in which a battery module 12″ and a battery module 12 are connected to the power contacts of the battery management system 14. In the configuration shown, the battery module 12″ is equipped with sixteen (16) battery cells and the battery module 12 with eight (8) battery cells. In order to account for the differing capacitance of the battery modules, the battery module 12″ is connected to the power contacts 20, 20′, whereas the battery module 12 is connected to the terminal 20″.

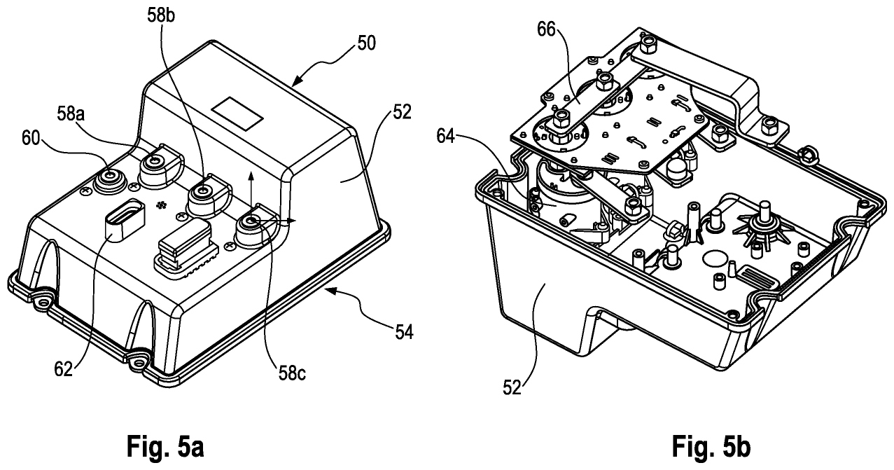

FIG. 5a shows a battery management system 50 with its housing 52. The housing 52 comprises a base 54. The connection between the housing 52 and base 54 is sealed off by a circumferential seal. The battery management system 50 comprises three power contacts 58a, 58b and 58c. The battery management system 50 is connected to one or more battery modules via the power contacts 58a-c. Output from the battery management system takes place via a contact 60. In addition, a protruding border 62 for a plug connector can be seen on the housing 52. The border 62 forms a wall.

FIG. 5b shows the battery management system in a view from below with the base plate removed. The housing 52 is hollow and comprises a cavity in its dome for receiving the contactor 64. The contactors 64 are interconnected via a power bus 66. Each contactor 64 also comprises a current sensor, which detects a critical current strength and opens the contactor.

The energy storage device shown in the above-described exemplary embodiments is configured as a decentralized energy storage system comprising a battery management system and one or more battery modules. By providing the battery management system as a separate component, switches and current sensors can be arranged in the battery management system, thus simplifying the design of the battery modules. The battery modules having different capacitances can also be used with the battery management system without same having to be altered.

### LIST OF REFERENCE NUMBERS

10 Industrial truck
12 Battery module
12′ Battery module
12″ Battery module
14 Battery management system
16 Positive terminal
16′ Positive terminal
18 Line
18′ Line
20 Power terminal
20′ Power contact
22 Negative terminal/Contact
22′ Contact
24 Bus bar
26 Negative terminal/Terminal
28 Positive terminal/Contact
30 Output terminal
32 Charging socket
34 Plug socket
36 Contact
38 Contact
40 Terminal
42 Terminal
44 Terminal contact
45 Terminal contact
50 Battery management system
52 Housing
54 Base
58a Power contact
58b Power contact
58c Power contact
60 Contact
62 Border
64 Contactor
66 Power bus

1. An industrial truck comprising:
at least one electrically powered drive; and
an electrical energy storage device comprising,
a battery management system (BMS) comprising,
a first housing including one or more electrical terminals, and
at least one switch, and
at least one battery module comprising a second housing including one or more electric terminals,
wherein the at least one switch is configured to interrupt a connection between the at least one battery module and the at least one electrically powered drive.

2. The industrial truck according to claim 1, wherein the at least one battery module comprises a plurality of battery cells.

3. The industrial truck according to claim 1, wherein the battery management system is connected to an on-board charging socket.

4. The industrial truck according to claim 1, further comprising a bus bar module configured to connect a negative terminal of the least one battery module to the at least one electrically powered drive.

5. The industrial truck according to claim 1, wherein at least two or more battery modules are provided and are configured to be controlled by the battery management system.

6. The industrial truck according to claim 1, wherein the at least one battery module comprises a plurality of battery stacks, and wherein each of the plurality of battery stacks comprises at least one of a stack controller and a group of cell controllers.

7. The industrial truck according to claim 6, wherein each stack controller is connected to the battery management system.

8. The industrial truck according to claim 1, wherein the battery management system is positioned within a housing, wherein a plurality of power contacts for the battery modules and at least one output contact for electric loads are positioned on the housing, and wherein each of the plurality of power contacts comprises a contactor.

9. The industrial truck according to claim 8, wherein at least one of the plurality of power contacts and the at least one output contact is integrated with the housing.

10. The industrial truck according to claim 8, wherein at least one of the plurality of power contacts and the at least one output contact is injection-molded with the housing.

11. The industrial truck according to claim 8, further comprising current sensors for the plurality of power contacts.

12. The industrial truck according to claim 1, wherein the battery management system comprises one or more terminals for electric plug connectors.

13. An industrial truck comprising:
at least one electrically powered drive; and
an electrical energy storage device comprising,
a battery management system (BMS) comprising a first housing including one or more electrical terminals, and
at least one battery module comprising a second housing including one or more electric terminals.

14. The industrial truck according to claim 13, wherein the battery management system further comprises at least one switch.

15. The industrial truck according to claim 14, wherein the at least one switch is configured to interrupt a connection between the at least one battery module and the at least one electrically powered drive.

16. The industrial truck according to claim 13, wherein the at least one battery module comprises a plurality of battery cells.
